(19) United States
(12) Patent Application Publication
(10) Pub. No.: US 2006/0039545 A1
(43) Pub. Date: Feb. 23, 2006

(54) Multimedia based caller ID to identify an instant messaging client/user

(75) Inventors: Mahfuzur Rahman, South Brunswick, NJ (US); Cuneyt Akinlar, Eskisehir (TR); Ibrahim Kamel, Monmouth Junction, NJ (US); John Buford, Lawrenceville, NJ (US); Alan Kaplan, Princeton, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/922,287

(22) Filed: Aug. 19, 2004

(51) Int. Cl. H04M 1/56; H04M 15/06

(52) U.S. Cl. 379/142.01

(57) ABSTRACT

A caller identification system for an instant messaging service identifies the sender of a message to the recipient. The caller identification system includes audio data, visual data, a private code, or other data indicative of the sender in an invite request. The recipient receives the invite request and is able to decide whether to allow a communication session with the sender based on the data.

### FIELD OF THE INVENTION

The present invention relates to multimedia communication protocol, and more particularly to enhancing instant messaging with caller identification.

### BACKGROUND OF THE INVENTION

Instant Messaging (IM) allows sending and receiving messages in real-time independent of location and is intended for immediate end-user delivery. IM messages are typically grouped together in brief live conversations. IM is often available as a service within intranets and IP networks.

Session Initiation Protocol (SIP) is an applicaton-layer, text-based, client-server protocol modeled after HTTP/SMTP protocols. SIP is the standard IETF (Internet Engineering Task Force) signaling protocol used for setting up, controlling, and dismantling of interactive communication sessions such as Instant Messaging. Initially, SIP was developed for Internet telephony applications, multimedia distribution, and multimedia conferences.

SIP sessions between users are created by SIP invitations that carry session descriptions. The session descriptions allow users to agree on a set of compatible media types. SIP uses proxy servers to route requests to a user's current location, to authenticate and authorize users for services, to implement provider call-routing policies, and to provide features to users.

SIP has been extended to allow for IM. SIMPLE (SIP for Instant Messaging and Presence Leveraging) is an open standard IETF that includes a set of SIP extensions that support Presence and Instant Messaging. “Presence” is the availability of an individual to send or receive messages. Presence can exist independently of IM capabilities. IM capabilities are an enhancement to presence. Additionally, SIMPLE allows instant messages to be sent directly to other clients, rather than through a server or the Internet.

Referring now to FIG. 1, an SIP invite request 10 includes an invite request header 12 and an invite body 14. The header 12 indicates a MIME (Multipurpose Internet Mail Extension) content type of the invite request 10. For example, the header 12 may indicate a application or SDP (Session Description Protocol) content type. The invite body 14 includes an SDP message 16. The SDP message 16 describes media streams that will comprise the session being initiated.

### SUMMARY OF THE INVENTION

A caller identification system for an instant messaging service comprises a sender that generates a request to initiate a communication session. The request includes a request body that further includes data of two or more message content types, wherein the data is indicative of the sender, and a request header that indicates that the request body includes data of the two or more message content types. A recipient receives the request and initiates the communication session with the sender if the data indicates that the sender is a known sender.

A method for identification of a known user in an instant messaging service comprises generating an invite request that includes data indicative of a sender. The invite request is sent to a recipient user. It is determined whether the data indicates that the sender is a known user. A communication session is established if the sender is a known user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of an invite request according to the prior art;

FIG. 2 is a functional block diagram of an enhanced invite request header according to the present invention;

FIG. 3 is a functional block diagram of an instant messaging caller ID service according to the present invention; and

FIG. 4 is a flow diagram of an instant messaging caller ID service according to the present invention.

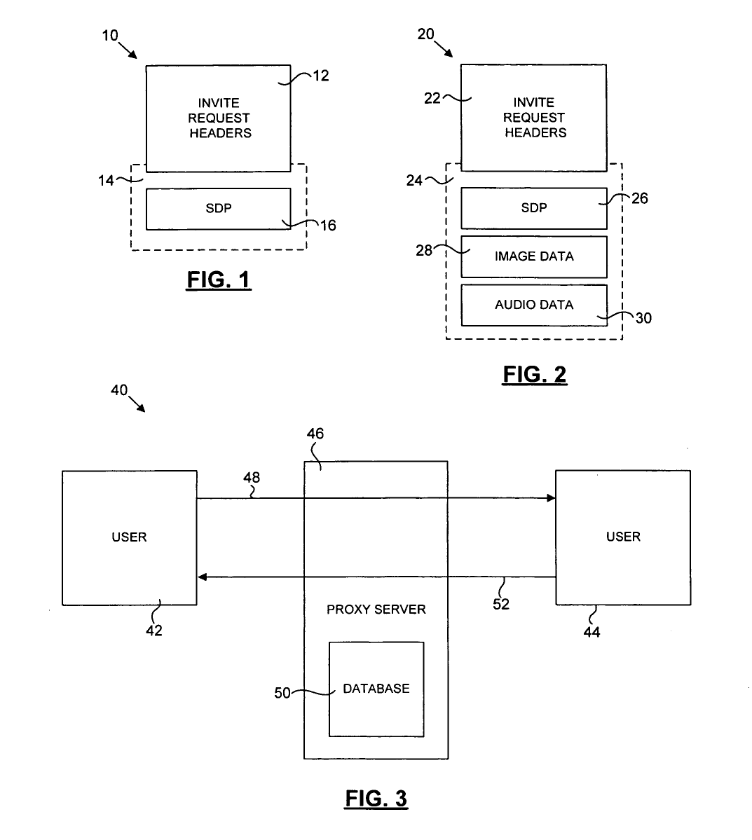

### DETAILED DESCRIPTION OF THE PREFERRED EMBODIMENTS

The following description of the preferred embodiment(s) is merely exemplary in nature and is in no way intended to limit the invention, its application, or uses.

Referring now to FIG. 2, an enhanced invite request 20 includes an invite request header 22 and an invite body 24. The invite body 24 includes an SDP message 26 and image data 28. The invite body 24 is able to include multiple types of MIME data. The image data 28 may include a visual image of the caller. Additionally, the invite body 24 may include audio data 30. The audio data 30 may include an audio message from the caller. In this manner, the recipient party is able to see the sending party's picture and/or listen to the sending party's audio message, in addition to seeing the sending party's name and SIP URL, prior to accepting or rejecting the request.

The invite request header 22 indicates a MIME content type of “multipart/mixed,” thereby indicating that the invite body 24 includes two or more content body parts, each having different MIME content types. Different parts of the invite body 24 are separated by a boundary separator. The boundary separator is specified in the invite request header 22. An exemplary enhanced invite request 20 including an SDP message and a gif image is shown in Appendix A. In further aspects of the invention, the invite body 24 may include a text message, audio files, video clips, or other content types. In still another aspect of the invention, the invite body 24 may include a URL or other reference that contains the necessary caller identification content.

Referring now to FIG. 3, an instant messaging caller ID service 40 is shown. The service 40 includes a first user 42, a second user 44, and a proxy server 46. A user desiring to initiate an IM session, for example the first user 42, generates a request message 48. The request message 48 includes an invite request as described in FIG. 2. Additionally, the request message 48 may include a digital signature. The digital signature ensures that the request message 48 originated from a known source. The digital signature may include a private code that the second user 44 provides to the first user 42. If the request message 48 does not include the private code, the second user 44 rejects the request to initiate an IM session.

The proxy server 46 receives the request message 48 from the first user 42. The request message 48 indicates that the second user 44 is the destination user. The proxy server 46 includes a database 50 of user information, such as the address for the second user 44. The proxy server 46 looks up the user information and forwards the request message 48 to the second user 44.

The second user 44 receives the request message 48. The second user 44 determines if the request message 48 includes the private code indicating that the first user 42 is a known user. The second user 44 may also receive any audio or visual data included with the request message 48 to determine if the first user 42 is a known user. The second user 44 generates a reply message 52 to indicate whether the request is accepted or rejected. The second user 44 sends the reply message 52 to the proxy server 46. The proxy server 46 forwards the reply message 52 to the first user 42. If the second user 44 accepted the request to initiate an IM session, the first user 42 can begin to send messages directly to the second user 44. In another aspect of the invention, the request message 48 may be sent to multiple recipients in order to initiate a group IM session.

In a further aspect of the invention, the information in the request message 48 may be encrypted. For example, the audio or visual data or the private code may be encrypted with the digital signature. In digital signature applications, the message is encrypted with a public key. The first user 42 and other known users use a public key obtained from the second user 44 to send messages to the second user 44. The second user 44 receives the encrypted message from the first user 42 and uses a private key to decrypt the encrypted message. The private key of the second user 44 corresponds to the public key distributed to the known users. In this manner, the second user 44 may authenticate that the first user 42 is a known user by way of the audio or visual data or the private code. Messages from unknown users can be automatically filtered out.

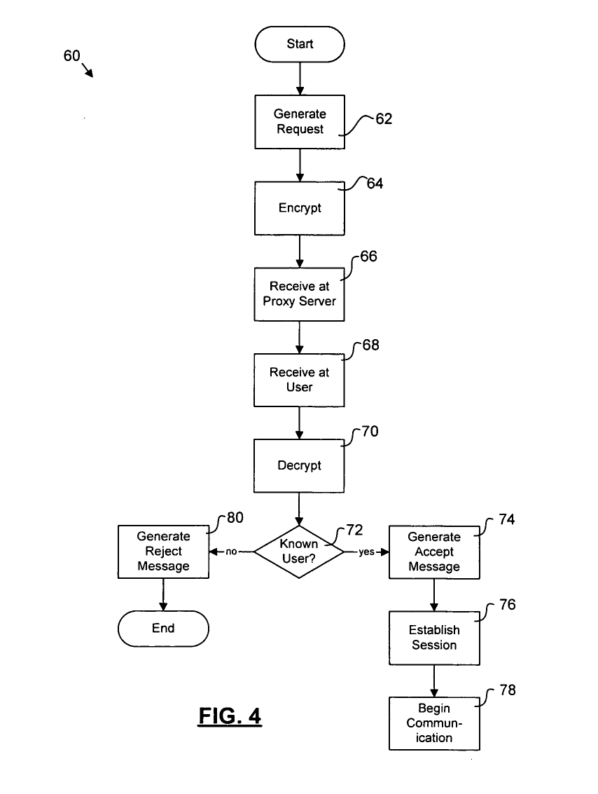

A method 60 for caller identification in IM applications is shown in FIG. 4. A first user generates an invite request at step 62. The invite request includes visual caller ID data, a private code, or other caller ID data in the invite body. The first user encrypts the caller ID data with a public key at step 64. The method 60 may use other authentication mechanisms as are known in the art, such as digital watermarking. At step 66, a proxy server receives the invite request and forwards the invite request to a second user. The second user receives the invite request at step 68. The second user decrypts the invite request at step 70. At step 72, the second user determines if the caller ID data indicates that the first user is a known user. For example, if the private code of the first user matches a private code of the second user, the second user may determine that the first user is a known user. If the first user is a known user, the second user generates an accept message and forwards the accept message to the proxy server at step 74. The proxy server forwards information necessary to establish an IM session with the second user to the first user at step 76. For example, the first user may require protocol information, IP address, and port data in order to establish an IM session with the second user. The first and second users may begin to communicate at step 78.

Alternatively, the second user may automatically generate a reject message at step 80 if the first user is not a known user. In this case, the proxy server does not transmit the necessary information to the first user, preventing the first user from establishing an IM session with the second user.

It is also to be understood that the present invention may be extended to other suitable protocols, such as Wireless Village (WV) instant messaging, presence protocol, and/or Extensible Messaging and Presence Protocol (XMPP).

The description of the invention is merely exemplary in nature and, thus, variations that do not depart from the gist of the invention are intended to be within the scope of the invention. Such variations are not to be regarded as a departure from the spirit and scope of the invention.

### APPENDIX A

From: user1@somedomain.com

To: user2@anotherdomain.com

Date: Sun, 21 Mar. 1993 23:56:48-0800 (PST)

Subject: Sample Mulitpart INVITE Message

MIME-Version: 1.0

Content-type: multipart/mixed; boundary=“boundary”

—boundary

Content-type: application/SDP; charset=ISO-10646

v=0

o=audit 2890844526 2890842807 5 IN IP4 134.177.64.4

s=SDP seminar

c=IN IP4 MG141.nortelnetworks.com

t=2873397496 2873404696

m=audio 9092 RTP/AVP 0 3 4

—boundary

Content-type: Image/gif;

—boundary—

What is claimed is:

1. A caller identification system for an instant messaging service comprising:
a sender that generates a request to initiate a communication session that includes:
a request body that includes data of two or more message content types, wherein at least a portion of the data is indicative of an identity of the sender; and
a request header that indicates that the request body includes data of the two or more message content types; and
a recipient that receives the request and initiates the communication session with the sender if the data indicative of the identity indicates that the sender is a known sender.

2. The system of claim 1 wherein the data includes at least one of audio data, visual data, and a private code.

3. The system of claim 2 wherein the recipient determines if the sender is a known sender based on at least one of the audio data, the visual data, and the private code.

4. The system of claim 2 wherein the visual data is an image of the sender.

5. The system of claim 2 wherein the audio data is a voice recording of the sender.

6. The system of claim 1 wherein the sender encrypts the data.

7. The system of claim 6 wherein the sender encrypts the data using at least one of a digital signature and a digital watermark.

8. The system of claim 1 further comprising a proxy server that receives the request from the sender and sends the request to the recipient.

9. A method for identification of a known user in an instant messaging service comprising:
generating an invite request that includes data indicative of a sender;
sending the invite request to a recipient user;
determining if the data indicates that the sender is a known user;
establishing a communication session if the sender is a known user.

10. The method of claim 9 wherein the data includes at least one of audio data, visual data, and a private code.

11. The method of claim 10 wherein the step of determining includes determining if the data indicates that the sender is a known user based on at least one of the audio data, the visual data, and the private code.

12. The method of claim 9 further comprising encrypting the data.

13. The method of claim 12 wherein the step of encrypting includes encrypting the data using at least one of a digital signature and a digital watermark.
